(19) United States
(12) Patent Application Publication
(10) Pub. No.: US 2013/0198017 A1
(43) Pub. Date: Aug. 1, 2013

(54) INFORMATION PROCESSING APPARATUS

(71) Applicant: Fujitsu Frontech Limited, Tokyo (JP)

(72) Inventor: Toshikazu MINEGISHI, Inagi (JP)

(73) Assignee: FUJITSU FRONTECH LIMITED, Tokyo (JP)

(21) Appl. No.: 13/733,308

(22) Filed: Jan. 3, 2013

(30) Foreign Application Priority Data
Jan. 26, 2012 (JP) 2012-014621

(51) Int. Cl. G06Q 20/20

(52) U.S. Cl. CPC G06Q 20/20
USPC 705/16

(57) ABSTRACT

A portable information processing apparatus connected to a peripheral device through a cable, including a main body unit connected to the peripheral device; a base unit to maintain standing upright the main body unit when in use, and to pass a cable to a bottom plane unit serving as a bottom plane when in use; and a tilting unit to tilt the main body unit from a state where the main body unit is upright when in use to a state where the man body is folded for transport, with respect to the base unit, wherein: the base unit has, at the bottom plane unit, an opening through which the cable passes so that the cable is guided to the bottom plane unit; and the opening has a handle so that the base unit is suspended in transport.

### CROSS REFERENCE TO RELATED APPLICATIONS

This application is based upon and claims the benefit of priority from the prior Japanese Patent Application No. 2012-014621, filed Jan. 26, 2012, the entire contents of which are incorporated herein by reference.

### BACKGROUND OF THE INVENTION

1. Field of the Invention

The present invention relates to an information processing apparatus for stores, represented by point-of-sale (POS) terminals used in stores such as a department store, a supermarket, a convenience store, and the like, and particularly to an information processing apparatus with excellent portability.

2. Description of the Related Art

Although conventional POS terminals have been large in size, have been designed to be installed in stores, and have not been easy to carry, recent developments in technology have reduced the size and weight of elemental components for such terminals, and POS terminals that are so light in weight as to be portable have been developed. However, POS terminals have a large display unit, and have to be stable because they are installed in stores, and accordingly they are not as light or small as a small PC (Personal Computer), which can be carried in one hand easily.

In view of the above situation, there have been suggestions regarding including handles in order to respond to requests for portability in information processing apparatuses that has not been very light, such as POS terminals. For example, Patent Document 1 suggests a PC that is provided with a foldable handle at the back that turns the display unit. Patent Document 2 supposes an electronic device that can be provided with a handle without using a dedicated part or mechanism by employing a battery pack detachable from the main body unit and using the vacant space in the main body unit after the removal of the battery pack.

Patent Document 1: Japanese Laid-open Patent Publication No. 2002-73211

Patent Document 2: Japanese Laid-open Patent Publication No. H06-21662

### SUMMARY

An information processing apparatus according to the present invention is a portable information processing apparatus connected to a peripheral device through a cable, including a main body unit connected to the peripheral device through the cable, a base unit to maintain the main body unit standing upright when in use, and to pass a cable from the main body unit to a bottom plane unit serving as a bottom plane when in use so that the cable is directed toward the peripheral device, and a tilting unit to tilt the main body unit from a state where the main body unit is upright for use to a state where the main body is folded for transport, with respect to the base unit, wherein the base unit has, at the bottom plane unit, an opening through which the cable passes so that the cable is guided from the main body unit to the bottom plane unit, and the opening has a handle in a state where the handle is folded by the tilting of the tilting unit so that the base unit is suspended in transport.

Also, in the information processing apparatus according to the present invention, the opening is provided with a finger receiving unit as the handle for stabilizing fingers that have entered the opening for transport. Also, in the information processing apparatus according to the present invention, the opening is provided with a plurality of the finger receiving units so that a plurality of fingers of a carrier's hand are received.

Also, in the information processing apparatus according to the present invention, the opening is provided with a guide unit to guide, to spaces between finger receiving units, a position of the cable that passes through the opening.

Also, in the information processing apparatus according to the present invention, the base unit has a weight for keeping stable the standing main body unit in the bottom plane unit within a range of the handle including a vicinity of the finger receiving unit. Also, in the information processing apparatus according to the present invention, the base unit has, on the bottom plane unit, a weight made mainly of a metal plate for keeping stable the standing main body unit, and the weight forms at least part of the opening, the finger receiving units are provided to the weight, and at least part of the weight serves as the handle.

Also, in the information processing apparatus according to the present invention, the information processing apparatus is a POS terminal.

The object and advantages of the embodiment will be realized and attained by means of the elements and combinations particularly pointed out in the claims.

It is to be understood that both the foregoing general description and the following detailed description are exemplary and explanatory and are not restrictive of the embodiment, as claimed.

### BRIEF DESCRIPTION OF THE DRAWINGS

FIG. 1 shows a system including a POS terminal and its peripheral devices as an information processing apparatus according to embodiments of the present invention;

FIG. 2 is a sectional view of a POS terminal 10 with a main body unit 20 standing upright;

FIG. 3 is a sectional view of the POS terminal 10 with the main body unit 20 in a folded state;

FIG. 4A is a perspective view showing the POS terminal 10 in a state when it is carried;

FIG. 4B is an enlarged view showing part A shown in FIG. 4A;

FIG. 5 is a sectional view showing the POS terminal 10 when it is to be carried as shown in FIG. 4A;

FIG. 6 shows how the POS terminal 10 is carried when the POS terminal 10 does not have the cables 100 connected to it;

FIG. 7 shows how the POS terminal 10 is carried when the POS terminal 10 has the cables 100 connected to it;

FIG. 8A shows a handle having guides to keep the cables between recesses; and

FIG. 8B is an enlarged view showing scope B shown in FIG. 8A.

### DESCRIPTION OF THE EMBODIMENTS

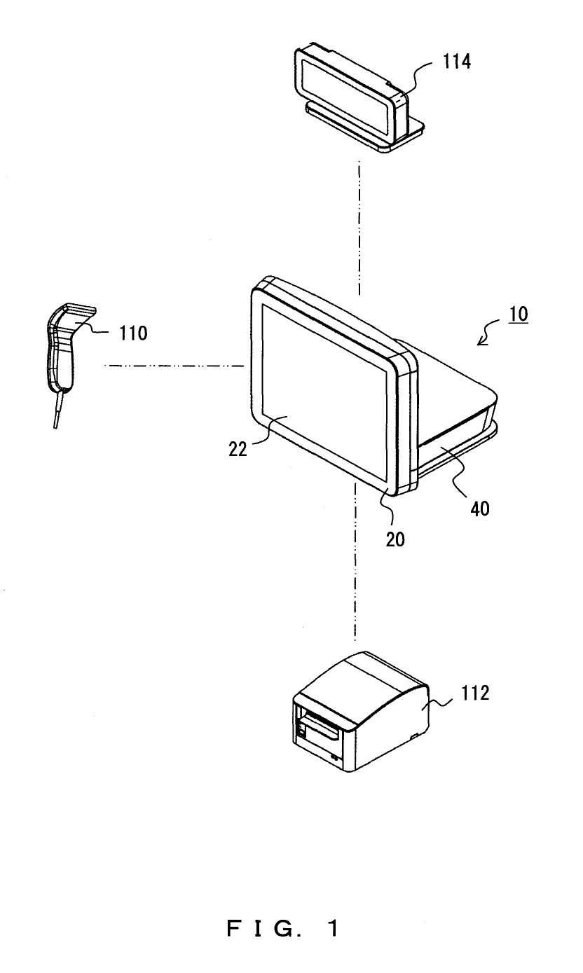

Hereinafter, embodiments of the present invention will be explained by referring to the drawings. FIG. 1 shows a system including a POS terminal and its peripheral devices as an information processing apparatus according to embodiments of the present invention.

A POS terminal 10 is an apparatus widely used in stores such as department stores, supermarkets, convenience stores, and the like as an information processing apparatus for sales management, item inventory, or the like.

As representative peripheral device connected to the POS terminal 10, a scanner 110, a printer 112, and a VFD (Vacuum Fluorescent Display) 114 are shown. The scanner 110 reads bar codes attached to items so as to transmit to the POS terminal 10 the codes (management numbers) corresponding to the items. The POS terminal 10 displays the corresponding prices, and calculates the total amount in accordance with the codes of the items, and stores such information.

The printer 112 prints receipts of items to be given to customers, in accordance with instructions from the POS terminal 10. The VFD 114 is a display unit for customers set on the upper portion of the POS terminal 10. The VFD 114 is set on the POS terminal 10 in a turnable manner so that item prices or the like are displayed towards customers. Also, as a peripheral device, a private code key pad (not shown) or the like may be set. Because the POS terminal 10 may be connected through LAN to a server that performs the overall control, a plurality of connection cables are connected to the POS terminal 10 in addition to the above peripheral device.

The POS terminal 10 mainly includes a main body unit 20 having a monitoring function and a base unit 40 for supporting the main body unit 20. The surface on the front side of the main body unit 20 is a touch panel 22. An LCD is provided to the inner side of the touch panel 22 in order to display operation instruction information for the touch panel and various types of other information.

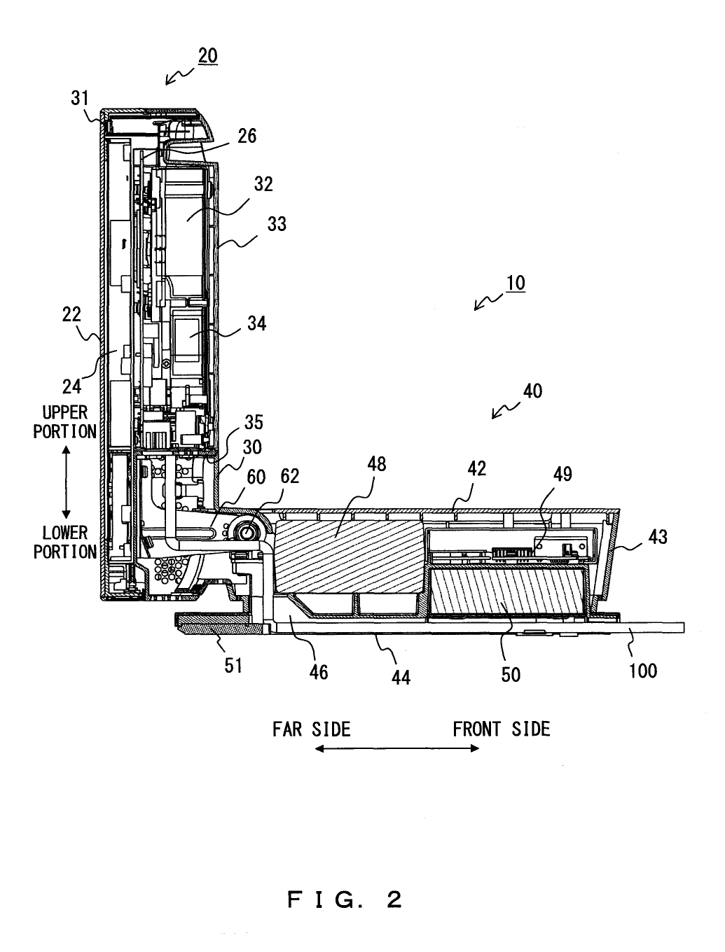

FIG. 2 is a sectional view of the POS terminal 10 with the main body unit 20 standing upright. The POS terminal 10 includes the main body unit 20, the base unit 40 serving as a stand to support the main body unit 20, and a tilt hinge 60 that is a tilting unit for attaching the main body unit 20 to the base unit 40 in a foldable manner. In the explanations of the base unit 40, the side having the main body unit 20 (the side of the touch panel 22) is referred to as the far side, while the other side is referred to as the front side. Also, in the explanations of the main body unit 20, the expressions upper portion and lower portion are used with references to the main body unit 20 standing upright.

The main body unit 20 has an approximately rectangular solid shape. In the main body unit 20, the touch panel 22, an LCD 24, a motherboard 26, a camera 31, a heat sink 32, a exhaust fan 34, and the like are provided. The touch panel 22 is provided on the plane opposite to the base unit 40. In the touch panel 22, the LCD 24, which is a thin type display device, is provided parallelly to the touch panel 22.

The plane opposite to the touch panel 22 of the main body unit 20 is protected by a rear cover 33. Below the rear cover 33, a connector cover 30 is provided. The connector cover 30 is attached to the bottom 35 of the main body unit 20 so as to cover connectors mounted on the main body unit 20. The connector cover 30 and the rear cover 33 are items made by resin casting.

The motherboard 26 is provided parallelly to the LCD 24 at a position further inward than the LCD 24 included in the main body unit 20. The motherboard 26 is provided with a CPU for controlling the POS terminal 10 entirely, a memory device for storing information temporarily, a control circuit for controlling the touch panel 22 or the LCD 24, and an interface circuit for controlling peripheral devices such as a scanner or the like.

Also, the motherboard 26 is provided with a plurality of connectors to which cables connected to peripheral devices are connected. A USB connector, LAN connector, RS232C connector, IEEE1394 connector, and the like are possible types of connectors, and connectors compatible with the cables of peripheral devices are used. The terminals of the connectors are mounted on the bottom of the motherboard 26, and only receptacles (not shown) are exposed to the external environment through a cover provided at the bottom 35 of the main body unit 20. In FIG. 2, the connectors (jacks) of the cables 100 are connected to the connectors (receptacles) mounted on the main body unit 20.

The camera 31 is an image pickup device for monitoring the inside of the store, and is set on the top of the main body unit 20. The heat sink 32 is attached to elements such as a CPU or the like so as to dissipate heat generated by the CPU or the like mounted on the motherboard 26. The exhaust fan 34 is provided in the vicinity of the heat sink 32. The exhaust fan 34 ventilates air from inside the main body unit 20 so as to emit heat radiated from the heat sink 32 to the outside.

The base unit 40 has an approximately rectangular solid shape. The outline of the base unit 40 is constituted of a base housing 43 that is in the shape of a box whose top plane is opened, and a top cover 42 covering the top plane of the base housing 43. The top cover 42 and the base housing 43 are made by resin casting. However, they may be made by using other techniques, and may be made of other materials. In the base housing 43, an adapter 48, a power board 49, a battery 50, and the like are provided. The adapter 48 converts, into DC power, external AC power provided through an AC power cable. The power board 49 converts the DC voltage obtained through the conversion by the adapter 48 into voltages for driving the CPU, the touch panel 22, the LCD 24, etc. of the main body unit 20, and supplies the resultant voltages to respective units in the main body unit 20. The battery 50 is a backup power source to be used when electric power interruptions or the like have stopped the power supply of the AC power. A secondary battery such as, for example, a lithium-ion battery or nickel-hydrogen cell is used as the battery 50.

The base unit 40 has an opening 46 on the far side of a bottom plane unit 44. The opening 46 is a hole through which the cables 100 connected to the bottom 35 of the main body unit 20 pass to the bottom plane unit 44. The opening 46 will be described later in detail.

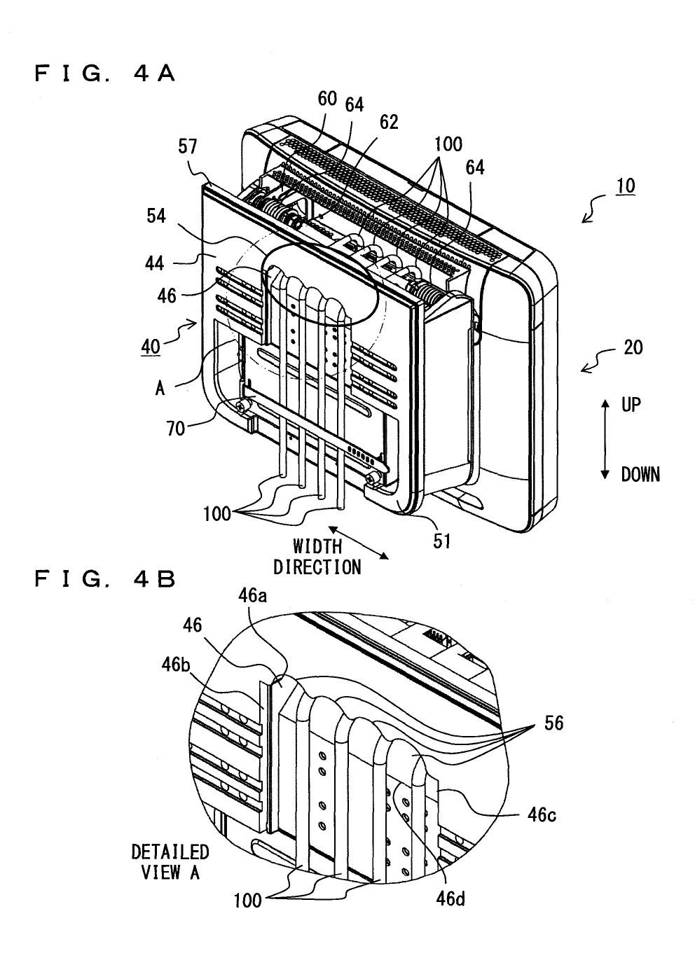

Also, a base weight 51 is provided to the bottom plane unit 44. The base weight 51 is attached to the base housing 43. The base weight 51 is a balancer (weight) for keeping stable the main body unit 20 in a standing state. When the main body unit 20 is in a standing state, the center of gravity is shifted to the far side, and accordingly the balancer is used to maintain balance in order to prevent the main body unit 20 from being overturned. The base weight 51 is formed of a plate of high density metal (such as stainless steel for example) or a plate of resin containing such a metal material. The planar shape of the base weight 51 will be explained in FIG. 4A.

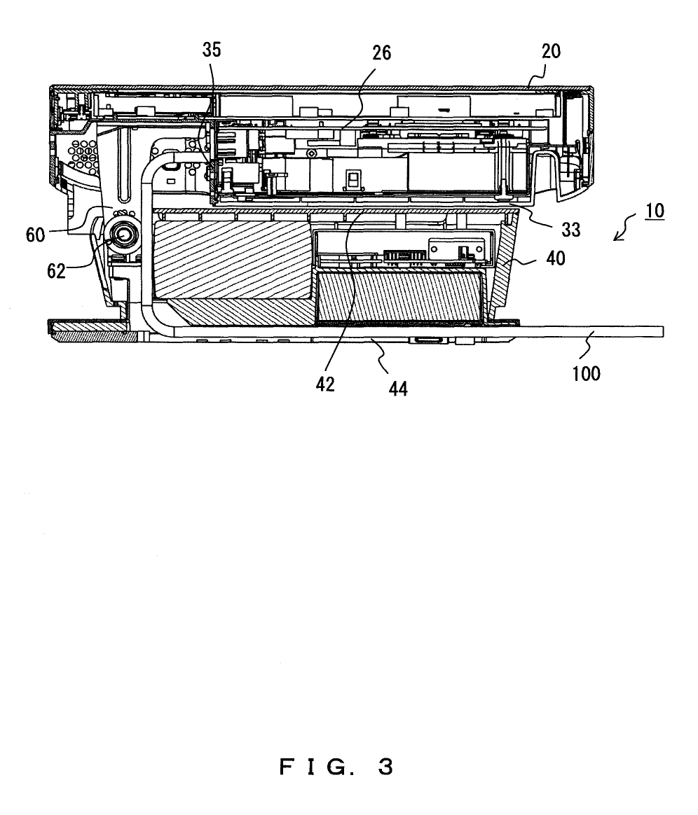

The tilt hinge 60 is a tilting unit for making the main body unit 20 be able to be folded into the base unit 40. The main body unit 20 and the base unit 40 are coupled to each other by the tilt hinge 60. The main body unit 20 tilts about tilting shafts 62 of the tilt hinge 60 by about ninety degrees with respect to the base unit 40 so that the position changes from the standing state shown in FIG. 2 to the folded state shown in FIG. 3. The tilting shaft 62 is provided to the far side of the base unit 40 and the bottom of the main body unit 20 shown in FIG. 2, and the shaft line runs in the direction orthogonal to the drawing sheet. The position of the connectors of the main body unit 20 is in the vicinity of the shaft line of the tilting shaft 62; however, the tilting shafts 62 are provided to the right and left edges so that they does not interfere with the cables 100. The tilt hinge 60 will be described later by referring to FIG. 4A.

The route (path) of the cables 100 will be explained. Note that FIG. 2 shows the route of the cables 100 in a simplified manner. On the far side of the base unit 40 and the bottom of the main body unit 20, a space is secured in which the cables 100 can move to some extent.

When the main body unit 20 is in a standing state as shown in FIG. 2, the cables 100 run downward from the connectors of the main body unit 20, extend toward the tilting shaft 62 (right direction), and enter the opening 46 of the base unit 40. Further, the cables 100 pass through the opening 46 so as to reach the bottom plane unit 44, and run along the bottom plane unit 44 to the front side, and are exposed to the outside from the front side of the base unit 40.

FIG. 3 is a sectional view of the POS terminal 10 with the main body unit 20 in a folded state. The main body unit 20 tilts by ninety degrees about the tilting shafts 62 of the tilt hinge 60 in the clockwise direction. The main body unit 20 is folded into the base unit 40 to the position at which a plane of the rear cover 33 of the main body unit 20 overlaps the top cover 42 of the base unit 40. The motherboard 26 is approximately parallel to the bottom plane unit 44. The main body unit 20 is locked by locking means (not shown) when the main body unit 20 is folded into the base unit 40.

The route of the cables 100 change in accordance with the folding of the main body unit 20. FIG. 3 shows an example where the cables 100 bend by ninety degrees at the connectors of the main body unit 20, and enter the opening 46 vertically. However, the bending manner and the route of the cables 100 change according to the diameter, the rigidity, and the like of the cables 100. There is enough space inside as to allow deformation of the cables 100 to avoid applying unnecessary stress to the cables 100 when the main body unit 20 is folded.

FIG. 4A is a perspective view showing the POS terminal 10 in a state where it is carried. The state of the POS terminal 10 when it is being carried is a state in which the bottom plane unit 44 stands vertically so that the far side of the base unit 40 becomes a higher side.

The base weight 51 has a shape that surrounds the bottom plane unit 44 while avoiding the route of the cables 100. The base weight 51 includes a region that covers the base unit 40 entirely over the width direction at the far side region (upper side in this figure) of the bottom plane unit 44 and a long and narrow part along the right and left ends at the front side (lower side in this figure) of the bottom plane unit 44. The base weight 51 has been cut over a prescribed length along the front side edge of the bottom plane unit 44 so that the cables 100 are allowed to pass over.

The tilt hinge 60 is a unit including the tilting shafts 62, torsion springs 64, and attachment plates (not shown) to hold this. Pairs of the tilting shafts 62 and the torsion springs 64 are provided to the right and left ends of the attachment plate, which is laterally long. The tilting shafts 62 and the torsion springs 64 are provided to the right and left ends in the width direction of the base unit 40. The torsion springs 64 are provided around the tilting shafts 62 in order to force the main body unit 20 to a standing position. There is a space between the tilting shafts 62 on both ends so that the cables 100 to be connected to the main body unit 20 pass through the space to enter the opening 46.

The cables 100 pass through the opening 46, and are discharged in such a manner that the cables 100 are suspended downward along the bottom plane unit 44. Note that the part of the cables 100 that extend beyond the base unit 40 are not shown.

Further, a cable band 70 is provided to the bottom plane unit 44. The cable band 70 is a member that takes the form of a resin band provided along the width direction of the base unit 40, prevents a plurality of cables 100 from being tangled when they pass through the bottom plane unit 44, and limits the movement of the cables 100 by pressing them onto the bottom plane unit 44.

A region including the opening 46 provided to the bottom plane unit 44 serves as a handle (a handle or a grip) 54, which is a part to be gripped by hand when the system is being carried. Fingers enter the opening 46, and the pads of the fingers are received by the upper side of the opening 46. Also, the portion between the opening 46 and an upper surface 57 of the bottom plane unit 44 is a portion that the palm comes into contact with so that in practice that portion is gripped.

The opening 46 is provided at the central position in the width direction of the bottom plane unit 44 in order to maintain balance when the apparatus is carried. Also, the opening 46 is provided at a position close to the upper surface 57 of the bottom plane unit 44 so that when the apparatus is carried, the fingers of the carrier can easily be received by the opening 46. An upper side 46a, a left plane 46b, and a right plane 46c of the opening 46 are constituted by the base weight 51, and a lower side 46d is constituted by the base housing 43.

FIG. 4B is an enlarged view showing scope A, enclosed by a dashed-double dotted line including the handle 54 and having the opening 46 at the center. Four semicircular recesses 56 are provided to the upper side of the opening 46 to form a corrugated line. The successive recesses 56 forming a corrugated line serve as a finger receiving unit in the handle 54. There are four recesses 56 so as to correspond to the number of fingers, and the intervals between the recesses also correspond to the intervals of the fingers (for example, 1 through 3 centimeters). Because the upper side of the opening 46 is constituted by the base weight 51, the finger receiving unit is also formed on the base weight 51. Further, the shape of the recesses 56 at the opening 46 allows users to recognize that the opening 46 is a handle more clearly than a case in which the opening 46 exists alone. Thereby, it is also possible to avoid a situation in which a carrier grips a portion that is not strong enough and thereby deforming or breaking that portion.

Also, it is desirable for the recesses 56 to be set at a position in the width direction that does not cause interference with the cables 100 so that fingers entering the recesses 56 functioning as the finger receiving unit are not interfered with by the cables 100 passing through the opening 46. However, the cables 100 are allowed to move slightly in the width direction, and the recesses 56 may be provided at an arbitrary position. It is also possible to chamfer the edge of each recess so that the gripping fingers are not injured. Further, the above described shape, number, and intervals of the recesses are only exemplary, and other shapes, numbers, and intervals may be employed as a matter of course.

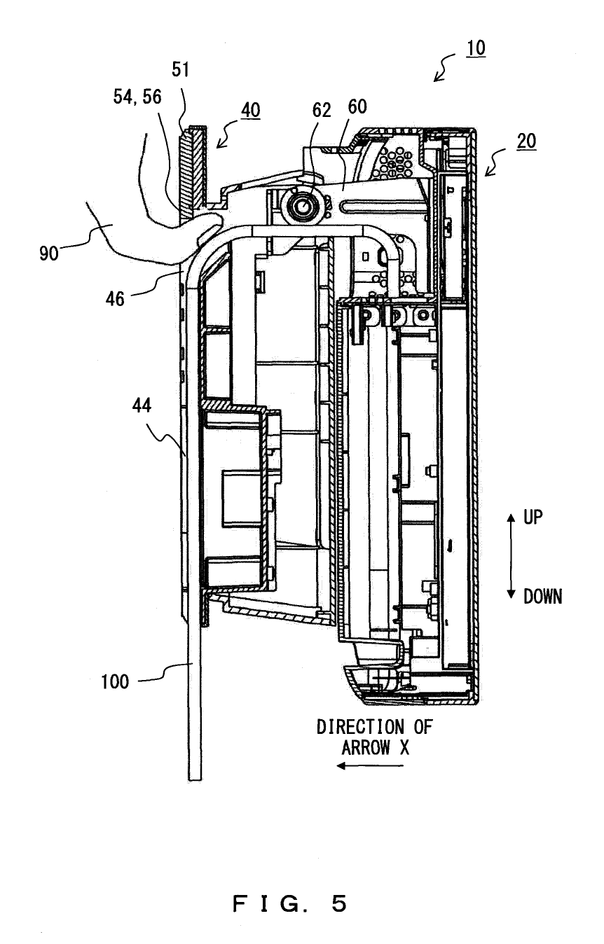

FIG. 5 is a sectional view showing the POS terminal 10 when it is to be carried as shown in FIG. 4A. In FIG. 5, the lower portion of the POS terminal 10 faces the ground. The POS terminal 10 is in a folded state, and the far side of the bottom plane unit 44 of the base unit 40 faces upward. At the right side in FIG. 5, there is the main body unit 20, and at the left side, there is the base unit 40. A situation where a hand 90 is received by the opening 46 is shown. Also, the space inside the opening 46 is the space between the tilting shafts 62 provided to both ends of the tilt hinge 60, and in this space, the cables 100 can move in the backward, forward, and side-to-side directions. Accordingly, even if there are cables 100 in the space into which fingers are to enter, the fingers push the cables 100 into an inner vacant space, avoiding a situation in which the cables 100 stop the fingers from entering.

Also, the base weight 51 is provided to the upper portion of the opening 46, and thus part of the base weight 51 constitutes the handle 54. Because the weight of the entire POS terminal 10 is applied to the handle 54 when the apparatus is carried, the handle 54 has to be strong enough. The base weight 51 is made of metal or resin including a metal material as described above, and thus the base weight 51 is strong enough, allowing the base weight 51 to be used as the handle 54 to bear the entire weight. By using the base weight 51 also as the handle 54, it is possible to eliminate the necessity of providing a new member such as the handle 54.

The base unit 40 stores relatively heavy elemental components (such as a power supply unit or a battery) in order to make the main body unit 20 stand upright, and also includes the base weight 51, and accordingly the base unit 40 accounts for a large proportion of the entire weight of the POS terminal 10. Thus, in the state shown in FIG. 5, the gravity center of the entire POS terminal 10 in direction X in FIG. 5 is close to the left side, which has the handle 54. In other words, the gripped part is set to be close to the center of gravity of the entire POS terminal 10, achieving a better balance for carrying.

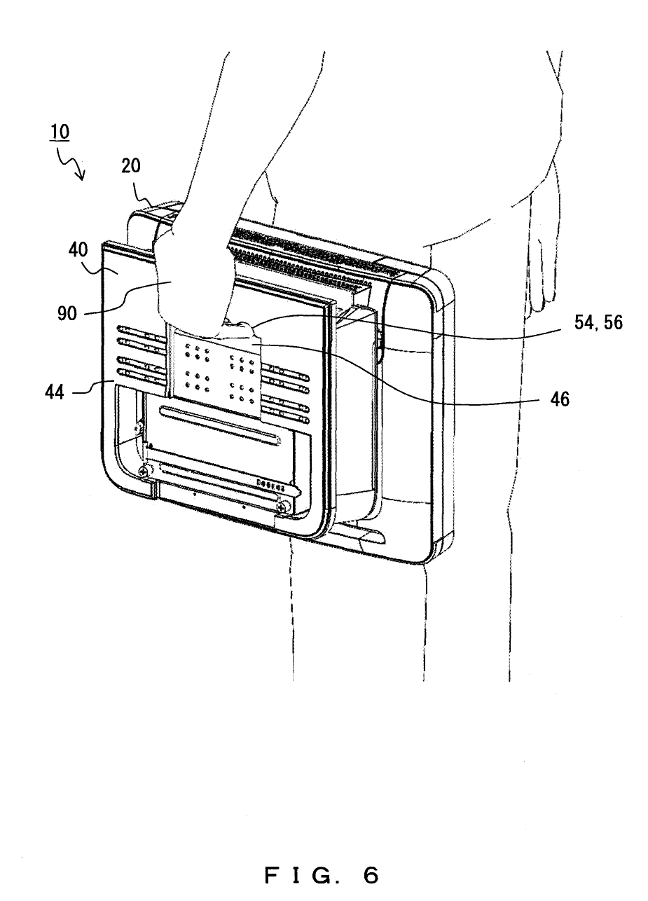

FIG. 6 shows how the POS terminal 10 is carried when the POS terminal 10 does not have the cables 100 connected to it. The POS terminal 10 is being carried by the left hand 90 with the main body unit 20 facing inward and the bottom plane unit 44 facing outward. Fingers of the left hand 90 are received by the recesses 56. The recesses 56 formed on the portion to receive fingers have eliminated the possibility of finger injuries and of dropping.

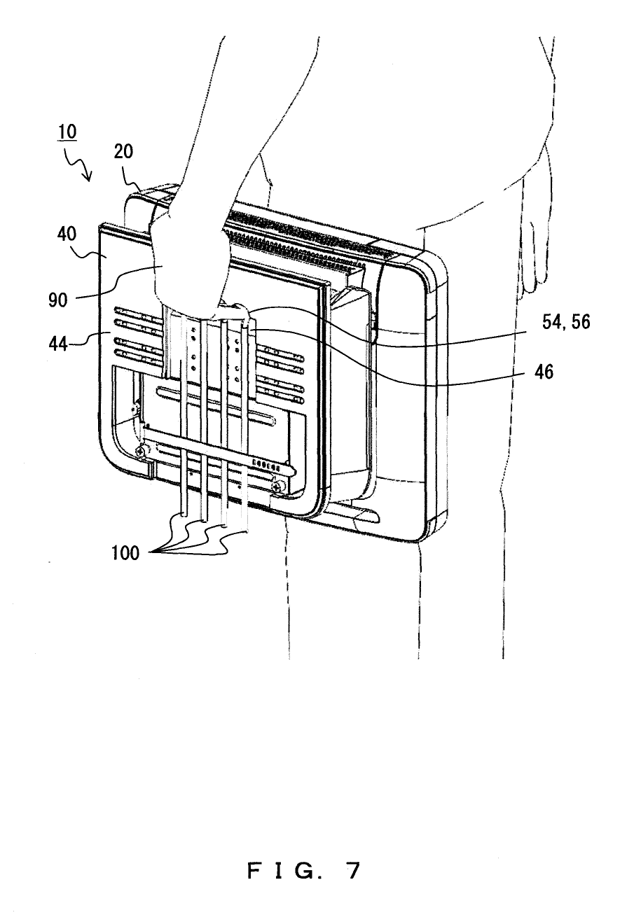

FIG. 7 shows how the POS terminal 10 is carried when the POS terminal 10 has the cables 100 connected to it. The portion of the cables 100 extending beyond the base unit 40 is omitted. Similarly to FIG. 6, the POS terminal 10 is being carried with the handle 54 gripped by the left hand 90 with the main body unit 20 facing inward and the bottom plane unit 44 of the base unit 40 facing outward. Because there is a space that allows for a slight movement of the cables 100 in the width direction or inside the opening 46, the cables 100 do not prevent gripping even when the cables 100 are connected and are overlapping at the positions of the recess 56. This makes it possible to carry the POS terminal 10 even when the cables 100 are connected.

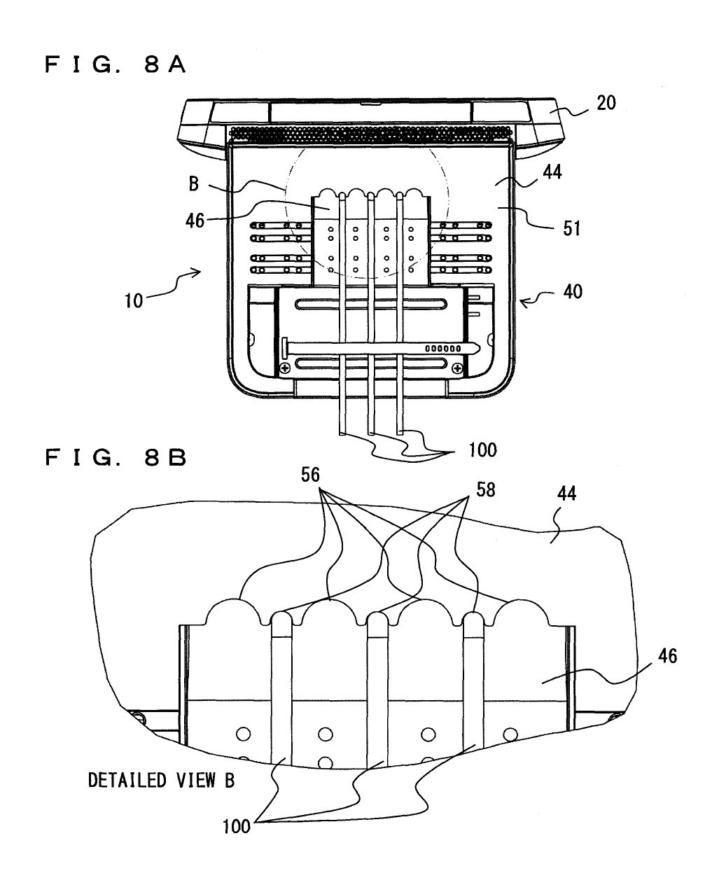

FIG. 8A shows a handle having guides to keep the cables between the recesses. FIG. 8A shows the base unit 40 as seen from the bottom. The POS terminal 10 in this example has the main body unit 20 standing upright. Similarly to FIG. 7, the cables 100 are connected to the POS terminal 10, and three cables 100 are passing through the opening 46.

FIG. 8B is an enlarged view showing scope B, which is enclosed by a dashed-double dotted line around the opening 46. On the upper side of the opening 46, i.e., between the recesses 56 formed on the base weight 51, guides 58 are provided to control the width directional position of the cables 100. The guides 58 are semicircular recesses provided between the recesses 56 in order to maintain the width directional position of the cables 100 so that the cables 100 do not enter the recesses 56. The guides 58 may be of a size to fit the cables 100 loosely or tightly.

Also, the guides 58 can employ not only a semicircular shape but also arbitrary shapes as long as they work as means for controlling the position of the cables 100. For example, while each pair of the recesses 56 has a single guide 58 between them in the above example, the guides 58 may be formed at the right and left ends of the opening 46. Arbitrary combinations can be employed between the recesses 56 and the guides 58. It is also possible to employ a configuration in which a single guide 58 controls all of the plurality of cables 100. Further, the guides 58 may be provided to the rear surface of the opening 46.

The above embodiments achieve at least the following effects.
1: It is possible to carry the POS terminal 10 easily without providing a dedicated handle because the opening for passing cables through is used as a handle.
2: Because recesses are provided in the finger receiving unit in the handle, it is easier to grip. Also, users will more readily recognize that the portion is a handle.
3: Because guides are provided for guiding cables into the opening for passing the cables through, cables do not interfere with fingers.
4: Because part of a base weight for the base unit is used as a handle, the POS terminal 10 can be transported easily without adding a new reinforcing member.
5: Because a handle is provided to the heavy base unit, it is possible to grip it at a position close to the center gravity of the POS terminal 10, and thus a good balance can be achieved when the POS terminal 10 is carried.
6: Because it is possible to grip it at a position close to the center gravity of the POS terminal 10 and thereby achieving good balance, the POS terminal 10 can be carried easily.

While a POS terminal has been used for explanations in the above embodiment, as a matter of course the present invention also applies to information processing apparatuses used for financial services, securities businesses, or communication services.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention.

What is claimed is:

1. A portable information processing apparatus connected to a peripheral device through a cable, comprising:
a main body unit connected to the peripheral device through the cable;
a base unit to maintain the main body unit standing upright when in use, and to pass a cable from the main body unit to a bottom plane unit serving as a bottom plane when in use so that the cable is directed toward the peripheral device; and
a tilting unit to tilt the main body unit from a state where the main body unit is upright when being used to a state where the man body is folded for transport, with respect to the base unit, wherein:
the base unit has, at the bottom plane unit, an opening through which the cable passes so that the cable is guided from the main body unit to the bottom plane unit; and
the opening has a handle in a state where the main body unit is folded into the base unit by the tilting of the tilting unit so that the base unit is suspended in transport.

2. The information processing apparatus according to claim 1, wherein:
the opening is provided with a finger receiving unit as the handle for stabilizing fingers that have entered the opening for transport.

3. The information processing apparatus according to claim 2, wherein:
the opening is provided with a plurality of finger receiving units so that a plurality of fingers of a carrier's hand are received.

4. The information processing apparatus according to claim 3, wherein:
the opening is provided with a guide unit to guide, to spaces between finger receiving units, a position of the cable that passes through the opening.

5. The information processing apparatus according to claim 2, wherein:
the base unit has a weight for keeping stable the standing main body unit in the bottom plane unit and within in a range of the handle including a vicinity of the finger receiving unit.

6. The information processing apparatus according to claim 2, wherein:
the base unit has, on the bottom plane unit, a weight made mainly of a metal plate for keeping stable the standing main body unit; and
the weight forms at least part of the opening, the finger receiving units are provided to the weight, and at least part of the weight serves as the handle.

7. The information processing apparatus according to claim 1, wherein:
the information processing apparatus is a POS terminal.
